(19) United States
(12) Patent Application Publication
(10) Pub. No.: US 2016/0080137 A1
(43) Pub. Date: Mar. 17, 2016

(54) SELF-LEARNING RESYNCHRONIZATION OF NETWORK ELEMENTS

(71) Applicant: Alcatel-Lucent Canada, Inc., Ottawa (CA)

(72) Inventors: Tibor Fasanga, Stittsville (CA); Guangnian Wu, Kanata (CA)

(73) Assignee: Alcatel-Lucent Canada, Inc.

(21) Appl. No.: 14/483,570

(22) Filed: Sep. 11, 2014

(51) Int. Cl. H04L 7/00; H04L 12/24

(52) U.S. Cl. CPC H04L 7/0033; H04L 41/02

(57) ABSTRACT

Various exemplary embodiments relate to a method of timing the delay of a resynchronization at a network management device, the method including defining an interval length; determining that a resynchronization is required; starting a first timer; determining the number of incoming event messages over a period of time the length of the interval; determining the number of incoming event messages exceeds a threshold amount; starting a second timer; and repeating the step of determining the number of incoming event messages over a period of time until the number of incoming event messages is less than the threshold amount.

### TECHNICAL FIELD

Various exemplary embodiments disclosed herein relate generally to data synchronization in SNMP managed networks.

### BACKGROUND

Simple Network Management Protocol (SNMP) is a set of standards within in the Internet Protocol Suite standard for managing devices on IP networks as defined by the Internet Engineering Task Force (IETF). SNMP is used in network management systems to administratively monitor network-attached devices such as, for example, routers, switches, bridges, hubs, servers and server racks, workstations, printers, or any other network-accessible device on which an SNMP agent is installed. Typically, one or more “network management stations” (NMS) or administrative computers monitors or manages a group of hosts or devices on a computer network, which may be referred to as network elements (NEs), each of which executes a software “agent” which reports information on the status of the device via SNMP to the NMS; each status update or series of status updates may be referred to as an “event.” Events are typically sent as UDP “Trap” messages. In the context of SNMP, NEs and their agents may be referred to interchangeably unless otherwise noted. When the NEs generate large number of events in a short period of time, messages may flood the network with various ill effects, including network congestion; this occurrence may referred to as an “SNMP trap storm.”

### SUMMARY

In light of the present need for optimization of resynchronization processes, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a non-transitory machine-readable storage medium encoded with instructions for execution by a network management device for timing the delay of a resynchronization at the network management device, the non-transitory machine-readable storage medium including instructions for defining an interval length; instructions for determining that a resynchronization is required; instructions for starting a first timer; instructions for determining the number of incoming event messages over a period of time the length of the interval; instructions for determining the number of incoming event messages exceeds a threshold amount; instructions for starting a second timer; and instructions for repeating the step of determining the number of incoming event messages over a period of time until the number of incoming event messages is less than the threshold amount. Some embodiments of the non-transitory machine-readable storage medium further include instructions for, when the second timer exceeds a predefined maximum, triggering a resynchronization process. In some embodiments of the non-transitory machine-readable storage medium, the instructions for determining the number of incoming event messages over a period of time further includes instructions for storing a first timestamp at a beginning of a first interval; instructions for storing a first message ID; instructions for storing a second timestamp at a beginning of a second interval; instructions for storing a second message ID; and instructions for calculating the number of event messages divided by the length of the interval, wherein the number of event messages is a value of the second message ID minus a value of the first message ID and the interval is a value of the second timestamp minus a value of the first timestamp.

Alternative embodiments further include instructions for, when the number of incoming event messages over a period of time is less than the threshold amount, verifying that the number of incoming event messages is less than the threshold amount for a number of intervals. In some embodiments, the instructions for verifying that the number of incoming event messages is less than the threshold amount includes instructions for setting a counter equal to a number of verification samples; instructions for determining the number of incoming event messages over a verification period of time the length of the interval; instructions for determining the number of incoming event messages is less than the threshold amount; instructions for decrementing the counter; and instructions for repeating the steps of determining the number of incoming event messages, determining the number of incoming event messages is less than the threshold, and decrementing the counter until the counter is equal to zero. In some embodiments the non-transitory machine-readable storage medium further includes instructions for, when the counter is equal to zero, storing a first resynchronization timestamp; starting a resynchronization process; storing a first resynchronization message ID; completing the resynchronization process; storing a second resynchronization timestamp; storing a second resynchronization message ID; and calculating the number of event messages received during resynchronization divided by a resynchronization interval, wherein the number of event messages received during resynchronization is a value of the second resynchronization message ID minus a value of the first resynchronization message ID and the resynchronization interval is a value of the second resynchronization timestamp minus a value of the first resynchronization timestamp.

Some embodiments further include instructions for determining the resynchronization process was not optimal. In some embodiments, instructions for determining the resynchronization process was not optimal includes instructions for determining that messages were dropped due to buffer overflow. In other embodiments, instructions for determining the resynchronization process was not optimal includes instructions for determining that a resynchronization is required. Alternative embodiments further include instructions for determining that the number of event messages received during resynchronization divided by a resynchronization interval is less than the threshold. Some embodiments further include instructions for setting the threshold to the greater of a predefined minimum threshold and a large percentage of the number of event messages received during resynchronization divided by a resynchronization interval. In some embodiments the percentage is ninety-five percent (95%).

Other embodiments further include instructions for determining that the number of event messages received during resynchronization divided by a resynchronization interval is greater than or equal to the threshold. Alternative embodiments further include instructions for determining the number of verification samples is less than a maximum number of verification samples; and instructions for increasing the number of verification samples by one (1). Other embodiments further include instructions for determining the resynchronization process was possibly optimal. Some embodiments further include instructions for calculating an average verification rate as the number of event messages received during the verification periods divided by the length of the interval times the number of verification samples. Some embodiments further include instructions for determining the average verification rate is greater than or equal to the number of event messages received during resynchronization divided by a resynchronization interval; instructions for generating a random number; instructions for calculating a percentage difference between the average verification rate and the number of event messages received during resynchronization divided by a resynchronization interval; instructions for determining that the percentage difference is greater than the random number; and instructions for decrementing the number of verification samples by one (1).

Various exemplary embodiments relate to a method of timing the delay of a resynchronization at a network management device, the method including defining an interval length; determining that a resynchronization is required; starting a first timer; determining the number of incoming event messages over a period of time the length of the interval; determining the number of incoming event messages exceeds a threshold amount; starting a second timer; and repeating the step of determining the number of incoming event messages over a period of time until the number of incoming event messages is less than the threshold amount. Some embodiments of the method further include, when the second timer exceeds a predefined maximum, triggering a resynchronization process. In some embodiments of the method, the step of determining the number of incoming event messages over a period of time further includes storing a first timestamp at a beginning of a first interval; storing a first message ID; storing a second timestamp at a beginning of a second interval; storing a second message ID; and calculating the number of event messages divided by the length of the interval, wherein the number of event messages is a value of the second message ID minus a value of the first message ID and the interval is a value of the second timestamp minus a value of the first timestamp.

Alternative embodiments further include, when the number of incoming event messages over a period of time is less than the threshold amount, verifying that the number of incoming event messages is less than the threshold amount for a number of intervals. In some embodiments, the step of verifying that the number of incoming event messages is less than the threshold amount includes setting a counter equal to a number of verification samples; determining the number of incoming event messages over a verification period of time the length of the interval; determining the number of incoming event messages is less than the threshold amount; decrementing the counter; and repeating the steps of determining the number of incoming event messages, determining the number of incoming event messages is less than the threshold, and decrementing the counter until the counter is equal to zero. In some embodiments, when the counter is equal to zero, the method further includes storing a first resynchronization timestamp; starting a resynchronization process; storing a first resynchronization message ID; completing the resynchronization process; storing a second resynchronization timestamp; storing a second resynchronization message ID; and calculating the number of event messages received during resynchronization divided by a resynchronization interval, wherein the number of event messages received during resynchronization is a value of the second resynchronization message ID minus a value of the first resynchronization message ID and the resynchronization interval is a value of the second resynchronization timestamp minus a value of the first resynchronization timestamp.

Some embodiments further include determining the resynchronization process was not optimal. In some embodiments, determining the resynchronization process was not optimal includes determining that messages were dropped due to buffer overflow. In other embodiments, determining the resynchronization process was not optimal includes determining that a resynchronization is required. Alternative embodiments further include determining that the number of event messages received during resynchronization divided by a resynchronization interval is less than the threshold. Some embodiments further include setting the threshold to the greater of a predefined minimum threshold and a large percentage of the number of event messages received during resynchronization divided by a resynchronization interval. In some embodiments the percentage is ninety-five percent (95%).

Other embodiments further include determining that the number of event messages received during resynchronization divided by a resynchronization interval is greater than or equal to the threshold. Alternative embodiments further include determining the number of verification samples is less than a maximum number of verification samples; and increasing the number of verification samples by one (1). Other embodiments further include determining the resynchronization process was possibly optimal. Some embodiments further include calculating an average verification rate as the number of event messages received during the verification periods divided by the length of the interval times the number of verification samples. Some embodiments further include determining the average verification rate is greater than or equal to the number of event messages received during resynchronization divided by a resynchronization interval; generating a random number; calculating a percentage difference between the average verification rate and the number of event messages received during resynchronization divided by a resynchronization interval; determining that the percentage difference is greater than the random number; and decrementing the number of verification samples by one (1).

It should be apparent that, in this manner, various exemplary embodiments enable increased efficiency in the timing of network element resynchronization. In particular, by adaptive resynchronization of network elements.

### BRIEF DESCRIPTION OF THE DRAWINGS

In order to better understand various exemplary embodiments, reference is made to the accompanying drawings, wherein:

FIG. 1 illustrates an exemplary system conducting operations and communications by which an NMS may determine that there is a gap in the traps that it has received from an NE;

FIG. 2 illustrates an exemplary method for detecting a trap storm, timing a needed resynchronization, and adjusting for network conditions;

FIG. 3 illustrates an exemplary scenario in which the method shown in FIG. 2 may take place;

FIG. 4 illustrates an exemplary hardware diagram for a device such as a device including a NMS or NE.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” as used herein, refers to a non-exclusive or (i.e., and/or), unless otherwise indicated (e.g., “or else” or “or in the alternative”). Additionally, the various embodiments described herein are not necessarily mutually exclusive and may be combined to produce additional embodiments that incorporate the principles described herein. Further, while various exemplary embodiments are described with regard to SNMP NMS systems, it will be understood that the techniques and arrangements described herein may be implemented to facilitate resource intensive operations during times of network congestion in other types of systems that implement multiple types of data processing or data structure.

For various reasons, including network congestion, during a trap storm some of the traps may not reach an NMS; if the NMS falls too far behind, the sending NE may lose track of the status updates it has sent. For example, each trap may have a data element that functions as a sequential identifier (Sequence ID), by which an NMS may determine the Sequence ID of the latest trap received from the NE. This sequence ID may be used to determine that traps have been lost by identifying trap gaps, a break in the sequential identifiers of the latest trap received from an NE by the NMS and the trap received from the same NE immediately prior to the latest trap—where the numbers are not sequential, at least one trap has been lost. The latest NE trap Sequence ID sent by an NE may be detected by an NMS from at least two sources—from the latest trap received from the NE, or by the NMS polling the NE for the last trap Sequence ID sent by the NE (note that in order to achieve polling the NE must be configured with an SNMP attribute that can be polled by NMS and which has the value of the latest generated trap sequence ID)—in some situations the NMS may poll for this information periodically.

Lost traps—or trap gaps may be detected by comparing the previous trap Sequence ID with the latest (current) Sequence ID received by NMS from messages received through normal operations or by polling. Note that not all gaps will generate a full resynchronization—some traps may be lost during normal network operations, and in some cases these traps may be re-sent by NEs without a full resynchronization. But during a trap storm or other problem where a great number of traps are lost, a full resynchronization may be required between the NMS and sending NE, where the entire status database of the sending NE must be uploaded to NMS using SNMP.

However, while the trap storm is still ongoing a full resynchronization may be counterproductive because it has the potential to worsen the trap storm, causing further traps to be lost or dropped, and consequently triggering another full resynchronization with the sending NE or other NEs that are attempting to send updates. Among other elements that may cause the resynchronization process to worsen a trap storm, the resynchronization generates extra network traffic which may cause more traps to be dropped by the transport network, typically due to network buffer overflow as the network becomes too congested with messages. Also, while resynchronization is in progress, the NMS must buffer the incoming traps, and to protect the NMS from running out of memory these buffers may overflow causing arriving traps to be intentionally dropped by the NMS. Therefore, up to the time a trap storm is over, full resynchronization of a lagging NE may not be efficient because it may result in multiple full resynchronizations as the additional messages contribute to the underlying network congestion that caused the resynchronization in the first place.

Some implementations delay a full resynchronization by a predefined fixed amount of time if a trap storm is detected. However, the fixed period of time may be a longer or shorter delay than required to clear the trap storm—in other words, NEs may be left unmanaged for longer than necessary if either network resources are underutilized (because the storm is long over when resynchronization finally begins) or overstretched (because the storm may be still ongoing when resynchronization begins).

As such, in order to increase the efficiency and accuracy of managing NEs, it is desirable for an NMS to detect a trap storm and accurately predict its duration so that resynchronization may commence immediately after the storm has cleared. Because the duration of the storms may vary depending on the cause of the storm, and other factors including network status, the process of predicting the duration of current and future storms may include a self-learning approach to improve the correctness of the prediction.

In view of the foregoing, it would be desirable to optimally time the resynchronization of NEs at NMS devices. In particular, it would be desirable to resynchronize NEs when trap storms are not occurring.

Referring now to the drawings, in which like numerals refer to like components or steps, there are disclosed broad aspects of various exemplary embodiments.

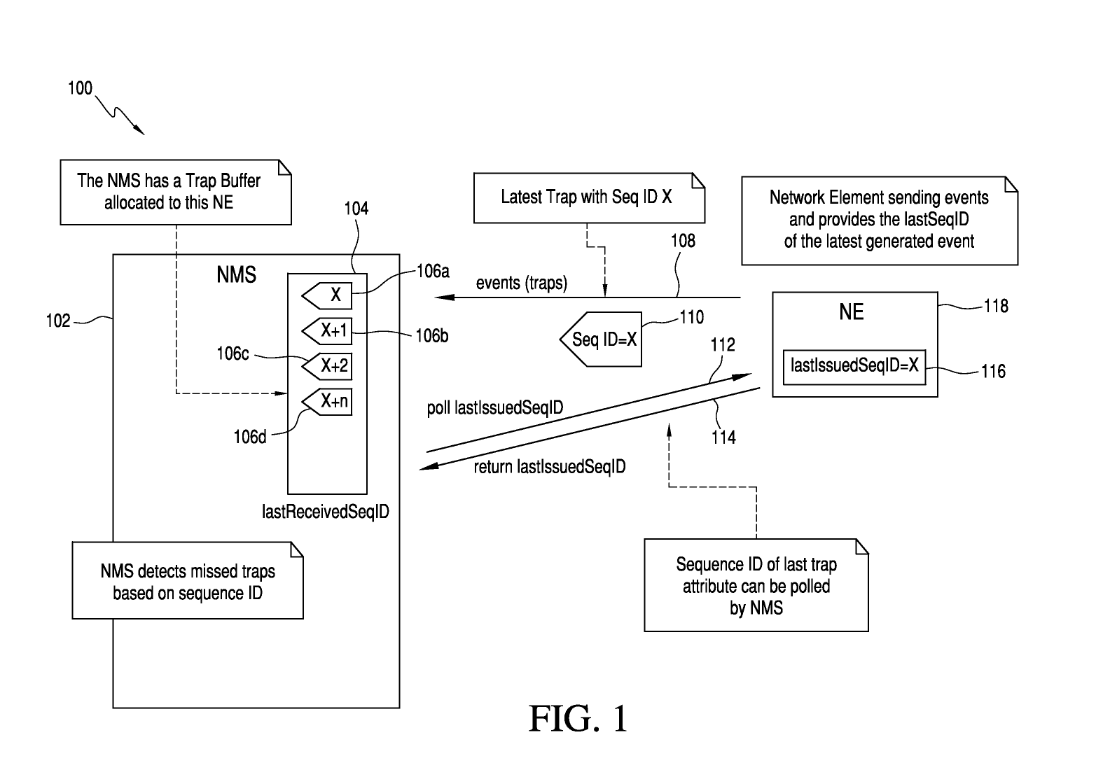

FIG. 1 illustrates an exemplary system conducting operations and communications by which an NMS may determine that there is a gap in the traps that it has received from an NE. NMS 102 in system 100 may have a buffer such as buffer 104 allocated to each network element it manages such as NE 118. The buffer may contain received but unprocessed traps including traps 106a, 106b, 106c, and 106d, each of which includes a sequence ID assigned by the sending NE 118. For example, trap 106a may have sequence ID x, trap 106b may have sequence ID x+1, trap 106c may have sequence ID x+2, and trap 106d may have a sequence ID of x+n, where n may be greater than 4. NMS 102 may derive values lastReceivedSequenceID and secondLastReceivedSequenceID from the values of the most recent 106d and second most recent 106c traps it has received.

The sequence IDs may be sequential for each trap assigned by the sending NE 118. For example, NE 118 may sent a trap 110 with Sequence ID x+n+1 to NMS 102 along communications path 108. The NMS 102 may be able to determine if there is a gap in the traps it has received. The NMS 102 may compare the Sequence ID of lastReceivedSequenceID and secondLastReceivedSequenceID to determine if there is a gap in the traps it has received. The NMS 102 may also poll the NE 118 as follows—the NMS 102 may reset a timer every time it receives a trap 110. If the timer reaches a threshold, for example, two minutes, NMS 102 may poll 112 NE 118 for the last issued Sequence ID, e.g. lastIssuedSeqID 116=x+n+1. The NMS 102 may maintain a separate polling timer for each NE it manages.

Once a trap gap is detected, the NMS 102 may perform an analysis to determine if a trap storm is a potential cause of the trap gap. A trap storm may occur if there are a high number of traps in a short time. Although traps may be lost during a trap storm, the detection of a trap storm is related not to how many traps are lost, but how many are received at a time, which in turn is related to how many traps are being sent by one or more NEs.

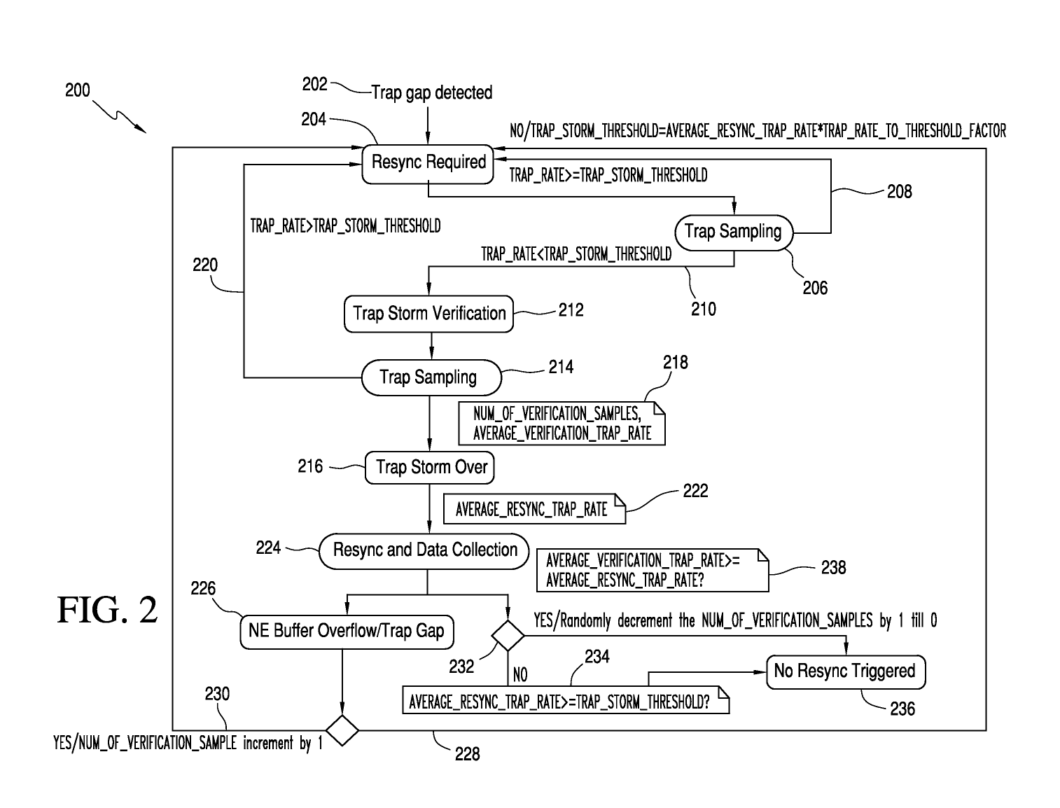

FIG. 2 illustrates an exemplary method for detecting a trap storm, timing a needed resynchronization, and adjusting for network conditions. Method 200 may be implemented in an NMS, for example, the NMS of system 100. Method 200 begins when a trap gap has been detected at step 202, for example, at NE 118. At step 204 it has been determined that a resynchronization is required, for example, with NE 118. Note that in some cases where a trap gap has occurred, it may be possible to recover the lost traps by polling the NE 118 for traps in its trap log. However, NEs typically maintain a limited number of traps in their trap log, and so for this example, it may be assumed that traps have been irrecoverably lost and therefore a resynchronization is required at step 204.

Once it is determined that a resynchronization is required, the NMS 102 may determine if there is an ongoing trap storm that may affect a resynchronization. The following steps will determine if there is a trap storm ongoing. Once the trap gap has been detected at step 202, a time TS_0 at which the gap was detected will be recorded along with the sequence ID SEQ_ID_0 of the last trap, which may be known either by the last received trap or last Sequence ID received by polling the NE 118. At step 206 NMS 102 will begin sampling incoming traps at a predefined repeating interval with a delay of SAMPLE_BASE_INTERVAL, for example, 1 second. At the next interval, which may be designated TS_1, the NMS may determine the current trap Sequence ID SEQ_ID_1 of the new latest trap (which again may be determined by polling the lastIssuedSeqID attribute from the NE 118 or may be determined based upon the last trap received by the NMS 102 from the NE 118 at time TS_1).

Using the Sequence ID SEQ_ID_0 of the trap at time TS_0 and the Sequence ID SEQ_ID_1 of the trap at time TS_1, the trap rate during the period from TS_0 to TS_1 may be calculated as the number of traps divided by the period of time, which may be expressed as TRAP_RATE=INTERVAL_NUMBER_OF_TRAPS/INTERVAL_ELAPSED_TIME, where the number of traps received in the interval is equal to the Sequence ID at time TS_1 minus the Sequence ID at time TS_0, which may be expressed as INTERVAL_NUMBER_OR_TRAPS=SEQ_ID_1−SEQ_ID_0, or more generally as INTERVAL_NUMBER_OR_TRAPS=SEQ_ID_<n>−SEQ_ID_<n−1>, where n is the sampling interval starting from 1 indicating the first sampling. The interval of elapsed time may be equal to the time recorded at TS_1 minus the time recorded at TS_0, which may be expressed as INTERVAL_ELAPSED_TIME=TS_1−TS_0, or more generally as INTERVAL_ELAPSED_TIME=TS_<n>−TS_<n−1>.

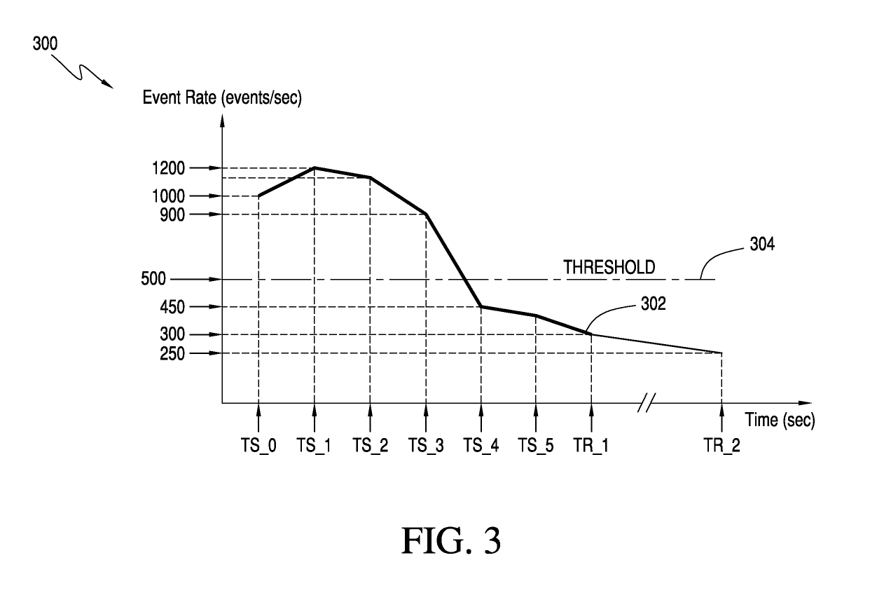

After calculating the trap rate, NMS 102 may compare the trap rate to a trap rate threshold, which may be designated TRAP_STORM_THRESHOLD. As will be seen, the threshold may be adjusted, but initially will be set by an administrator based upon a network configuration and demand, and the trap rate that NMS 102 is capable of handling without a buffer overflow or other fault—trap rate capabilities of the NMS 102 may be included in the documentation which may accompany NMS 102; a typical value may vary depending on the capabilities and configuration of the NMS and other factors, common values include 100 to 2000 traps/second. An exemplary value of 500 traps/second is shown with regards to FIG. 3, below.

If it is determined that the trap rate is at or above the threshold 208, the trap storm is determined to be ongoing and the method returns to step 204 to repeat another interval n+1 of sampling at step 206. Note that the value of TS_0 will be recorded by NMS 102 for purposes of the failsafe mechanism described below.

If it is determined that the trap rate is below the threshold 210, NMS 102 may conduct a verification process 212 to determine whether the trap storm is really over and the resynchronization process should begin. To determine whether the trap storm is really over, the NMS 102 may need to determine if the trap rate has fallen beneath the threshold rate merely temporarily because of a slight lull in incoming traps, or whether the decrease in trap rate has been established for a period of time.

At the beginning of verification process 212, the trap rate during the previous sampling period was above the trap rate threshold, and the trap rate during the current recorded period is below the trap rate threshold; this situation commences the verification period 212. Similar to step 206, at step 214 NMS 102 will begin sampling incoming traps at the predefined repeating interval, for a number of period intervals equal to a number of verification samples which may be designated and recorded as NUM_OF_VERIFICATION_SAMPLES. As will be seen, this number may increase or decrease, but initially will be set at three. For each such verification sample, if the trap rate is below the trap rate threshold then after the last sample it may be determined that the trap storm is over 216 and the NMS 102 may calculate the average verification trap rate, the average trap rate during the intervals in the verification period, which may be designated and recorded AVERAGE_VERIFICATION_TRAP_RATE. On the other hand, if the trap rate rises is above the trap rate threshold during the verification period 220, then the method returns to step 204 to resume sampling in step 206.

In step 216, when it is determined the trap storm is really over then resynchronization may begin. When resynchronization starts the NMS 102 may store the current time as TR_1 and current trap sequence number as SEQ_NUM_R_1. When the resynchronization is complete the NMS may store the current time as TR_2 and current trap sequence number as SEQ_NUM_R_2. From these values, the NMS 102 may calculate the average trap rate 222 during resynchronization as the Sequence ID at the beginning of resynchronization SEQ_NUM_R_2 minus the Sequence ID at the end of resynchronization SEQ_NUM_R_1, divided by the interval of elapsed time, which may be equal to the time recorded at TR_2 minus the time recorded at TR_1, which may be expressed as AVERAGE_RESYNC_TRAP_RATE is calculated as (SEQ_NUM_R_2−SEQ_NUM_R_1)/(TR_2−TR_1).

At step 224, the NMS 102 may use the statistics calculated and collected during the trap storm, verification period, and resynchronization to determine if the resynchronization occurred at an optimal time, or if some adjustments may be made to the prediction of the end of the trap storm. If the resynchronization is too easy or too hard, adjustment may be required, as follows.

At step 224, there may be two possible scenarios—either the resynchronization took place at a time that was possibly optimal or at a time that was not optimal. The NMS 102 may determine that the resynchronization took place at a time that was not optimal in at least two cases 226. The NMS 102 may determine that the time was not optimal if any traps were dropped due to its own trap buffer overflow because it could not handle the amount of events coming from the network, i.e. when number of traps received during resynchronization is greater than the size of the NMS Trap Buffer 104 allocated for the NE instance. The NMS 102 may also determine that the time was not optimal if it encounters another unrecoverable trap gap during the resynchronization. Note that polling for trap gaps as described above will continue regardless of the situation of the network—the NMS will monitor whether there is a trap gap at all times, even during trap storms. A trap gap during resynchronization may be considered not optimal even if the buffer has not overflowed, among other reasons, because it may be indicative of network problems which may be caused by the trap storm, and thus it still will not be optimal to resynchronize until the effects of the storm are over.

In any case, if the timing of the resynchronization is determined not to be optimal, it may lead to the determination that the average resynchronization trap rate (AVERAGE_RESYNC_TRAP_RATE) was too high—the trap rate averaged over the period of resynchronization was too high, and may lead to further network or buffer problems. If the average trap rate during resynchronization is less than the trap storm threshold, which may be expressed as AVERAGE_RESYNC_TRAP_RATE<TRAP_STORM_THRESHOLD, then the storm threshold rate may be determined to be set too high 228 because the NMS 102 still could not handle the trap rate during a resynchronization where the rate was lower than the threshold rate. Thus, the threshold rate must be lowered 228; the rate may be lowered to be a large percentage of the average resynchronization trap rate. In this example 228, the trap storm threshold may be adjusted by a large pre-defined percentage of the average trap rate during resynchronization, which may be expressed as setting TRAP_STORM_THRESHOLD AVERAGE_RESYNC_TRAP_RATE*TRAP_{—}RATE_TO_THRESHOLD_FACTOR, where the pre-defined percentage of the average trap rate during resynchronization may be, for example, 95%. Note that the threshold rate cannot be infinitely revised or fall below 0 for several reasons. For example, because the threshold is dropping by a percentage each time, at some point dropping the rate will be inefficient because only a small number of events will be dropped from the threshold rate, e.g. one event per second. Thus, the threshold will only be revised to a new threshold so long as the threshold is above a minimum rate, which may be expressed as TRAP_STORM_THRESHOLD>MIN_{—} TRAP_STORM_THRESHOLD. Note, too, that typically if the minimum storm threshold rate has been reached, it is a symptom that there are a lot of other things wrong with the system beyond the scope of reasonable adjustment of delaying resynchronization.

Otherwise, if the average trap rate during resynchronization is greater than or equal to the trap storm threshold, which may be expressed as AVERAGE_RESYNC_TRAP_RATE>=TRAP_STORM_THRESHOLD, then it is likely that resynchronization was launched when the trap storm was on the rise again, and thus likely that the verification period was not long enough 230. In this case, it may be prudent to adjust the verification period to wait a little bit longer before deciding the storm was really over, and thus the NMS 102 may increment the number of verification samples taken (NUM_OF_VERIFICATION_SAMPLES) by one, provided that it is still less than or equal to a maximum number of verification periods. In some embodiments, the maximum number of verification periods may be three.

Following either adjustment of the threshold 228 or the number of verification samples 230, the system will return to step 204 because during resynchronization 222 either the buffer has overflowed or traps have been irretrievably lost in transit, and therefore resynchronization must be re-run.

If in step 224 it is determined that resynchronization took place during a period that was possibly optimal, the resynchronization completed without a buffer overflow or an irrecoverable trap gap, but an additional adjustment may nevertheless take place. At step 232, a calculation is performed to determine if the resynchronization may be launched sooner, e.g., with fewer verification periods and thus less of a wait. At step 232, the NMS 102 may determine if the average verification rate is greater than or equal to the average resynchronization trap rate, which may be expressed as AVERAGE_VERIFICATION_TRAP_RATE>=AVERAGE_RESYNC_TRAP_RATE. If it is not 234, then as already mentioned no adjustment is required and the method ends at step 236. If the verification trap rate is greater than the resynchronization trap rate, the resynchronization trap rate may be a little bit lower than might be expected just following a trap storm (when the trap rate was elevated). However, the difference between the average verification rate and the average resynchronization trap rate may be small, and if the difference is insignificant it may not be prudent to decrease the number of verification samples taken before a determination is made that the trap storm is really over at steps 214-218.

Thus, at step 238 NMS 102 may generate a random number RAN between 0 and 1—if the random number is less than the difference between the average verification rate and the average resynchronization trap rate divided by the average verification rate (which, because in step 238 the average verification rate is greater than or equal to the average resynchronization trap rate will be the percentage of the difference over the average verification trap rate, a value between 0 and 1), then the NMS 102 will decrement the number of required verification samples by one, provided that the number does not fall below a minimum number which may be zero or one depending on the size and complexity of the system under management. This may be expressed as if RAN<(AVERAGE_VERIFICATION_TRAP_RATE AVERAGE_RESYNC_TRAP_RATE)/AVERAGE_VERIFICATION_TRAP_RATE then NUM_OF_VERIFICATION_SAMPLES may be decremented by 1 until 0 or 1.

In using the equation in step 238, if the difference between the verification trap rate and the resynchronization trap rate is high, then there is a higher chance that the random number, which is expected to be uniformly distributed between 0 and 1, will be lower than the percentage of the difference between them. In other words, if the difference between the trap rates is big, then there is a higher chance that the number of verification periods will be reduced. But if there is a small difference between the trap rates, then there is a low chance that the number of verification periods will be adjusted downwards. This makes it more likely that adjustments to the number of verification samples will reflect real network conditions, because if the percentage of the difference is small, it is less likely that there is a need to shorten the verification samples, but if the difference is great, there is a higher tendency to need to reduce the samples. More specifically, the lower the resynchronization trap rate (relative to the verification trap rate), the more chance the number of verification periods will be revised lower. A random number may be used rather than a fixed number because the percentage difference in trap rates may vary depending on unknown system conditions. After it is determined whether to adjust the number of verification samples at step 238, no resynchronization is required for the reasons discussed above, and the method concludes at step 236.

As noted above, although the method normally runs until resynchronization is complete at step 236, a failsafe is required for situations where a trap storm continues for an excessively long time. In some instances a trap storm may be so severe and long that it will not finish within a reasonable time frame such that the trap storm threshold will not be crossed. In such case a predefined maximum trap storm detection period, which may be expressed as MAX_STORM_DETECTION_PERIOD, may be taken into account. From TS_0, after a trap gap is first identified, a timer may be set to count down from the predefined maximum trap storm detection period. If the timer expires prior to a determination that the trap storm is over at step 216, resynchronization will be started immediately. Because the system may be slowed down further and another trap storm may result, or whatever problem or update caused the storm may be ongoing, the attempt at resynchronization at a failsafe time may not yield a positive result such that the resynchronization will result in a trap gap or buffer overflow and need to be reattempted. However, resynchronization must be conducted within a certain time to adhere to system protocols. Thus, setting a predefined maximum trap storm detection period will reconcile the method with the other protocol requirements of the NMS 102 even if the trap rate is continuously high for a long time. Note also that the predefined maximum trap storm detection period serves as an upper limit on the number of verification samples, because if it will kick in if the threshold is crossed but the verification period does not complete before the timer expires. Also note that in another scenario if the threshold is crossed and then re-crossed at least several times, entering and exiting the verification period without synchronizing, the predefined maximum trap storm detection period will eventually trigger.

An exemplary situation which may trigger a trap storm in an NMS 102 may be where a network element 118 configured with many thousands of LSPs (label switched paths) causes an LSP re-route triggered by a network event (e.g. the network link goes down due to hardware failure). In this case all LSPs may be re-routed and the NE 118 may generate many change events (SNMP traps) during the re-routing process, generating a trap storm which may be several minutes long (e.g. because many links may go through one element, so in the event of card failure or other problem, data needs to be re-routed around the link, which is a huge change for the network element). When the re-route is finished, the trap storm caused by that element will be over. Note too that a trap storm may effect only one NE, but depending on the topology of the network the storm may effect other NEs as well.

An exemplary scenario 300 in which the method may take place is shown in FIG. 3. At time TS_0 the trap rate 302 may be 1000, which may be above the exemplary threshold rate 304 of 500. As shown, the incoming trap rate 302 may remain above the threshold trap rate 304 from time TS_0 to TS_3. In the interval between TS_3 and TS_4 the rate 302 may fall below the threshold 304, and at time TS_4 the fall of the rate 302 below the threshold 304 may be detected, and the verification period will start. In this example, verification may continue for two periods, TS_4 through TS_5, and at time TR_1, with no rise in the trap rate 302 over the threshold trap rate 304, resynchronization may start at time TR_1 will continue until it is complete at time TR_2 (note that TR_2−TR_1 will vary somewhat unpredictably). Once the resynchronization process is complete at time TR_2, NMS 102 may calculate the average resynchronization trap rate and proceed to make any adjustments based on the statistics collected during the verification and resynchronization periods.

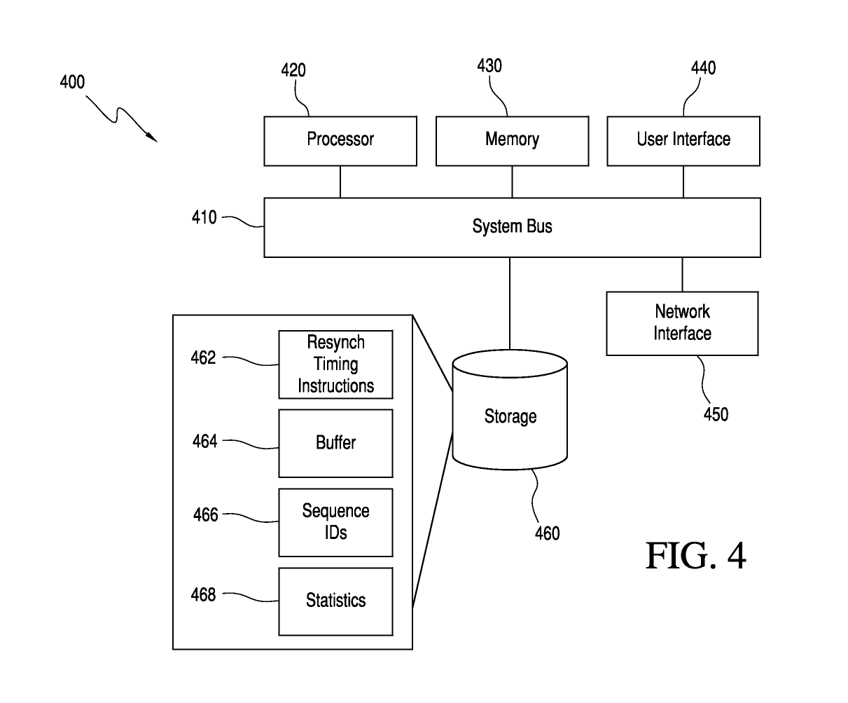

FIG. 4 illustrates an exemplary hardware diagram for a device 400 such as a device including a NMS or NE in a system 100. The exemplary device 400 may correspond to the NMS 102 or NE 104 of FIG. 1. As shown, the device 400 includes a processor 420, memory 430, user interface 440, network interface 450, and storage 460 interconnected via one or more system buses 410. It will be understood that FIG. 4 constitutes, in some respects, an abstraction and that the actual organization of the components of the device 400 may be more complex than illustrated.

The processor 420 may be any hardware device capable of executing instructions stored in memory 430 or storage 460. As such, the processor may include a microprocessor, field programmable gate array (FPGA), application-specific integrated circuit (ASIC), or other similar devices.

The memory 430 may include various memories such as, for example L1, L2, or L3 cache or system memory. As such, the memory 430 may include static random access memory (SRAM), dynamic RAM (DRAM), flash memory, read only memory (ROM), or other similar memory devices.

The user interface 440 may include one or more devices for enabling communication with a user such as an administrator. For example, the user interface 440 may include a display, a mouse, and a keyboard for receiving user commands.

The network interface 450 may include one or more devices for enabling communication with other hardware devices. For example, the network interface 450 may include a network interface card (NIC) configured to communicate according to the Ethernet protocol. Additionally, the network interface 450 may implement a TCP/IP stack for communication according to the TCP/IP protocols. Various alternative or additional hardware or configurations for the network interface 450 will be apparent.

The storage 460 may include one or more machine-readable storage media such as read-only memory (ROM), random-access memory (RAM), magnetic disk storage media, optical storage media, flash-memory devices, or similar storage media. In various embodiments, the storage 460 may store instructions for execution by the processor 420 or data upon with the processor 420 may operate. For example, the storage 460 may store instructions 462 for performing optimization according to the concepts described herein. The storage may also store Buffer Data 464, Sequence IDs 466, and Statistics 468 for use by the processor executing the optimization instructions 462.

According to the foregoing, various exemplary embodiments provide for optimal timing of resynchronization of NEs at NMS devices. In particular, by delaying resynchronization until an optimal time.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method of timing the delay of a resynchronization at a network management device, the method comprising:
defining an interval length;
determining that a resynchronization is required;
starting a first timer;
determining the number of incoming event messages over a period of time the length of the interval;
determining the number of incoming event messages exceeds a threshold amount;
starting a second timer; and
repeating the step of determining the number of incoming event messages over a period of time until the number of incoming event messages is less than the threshold amount.

2. The method of claim 1, the method further comprising, when the second timer exceeds a predefined maximum, triggering a resynchronization process.

3. The method of claim 1, wherein the step of determining the number of incoming event messages over a period of time further comprises:
storing a first timestamp at a beginning of a first interval;
storing a first message ID;
storing a second timestamp at a beginning of a second interval;
storing a second message ID; and
calculating the number of event messages divided by the length of the interval, wherein the number of event messages is a value of the second message ID minus a value of the first message ID and the interval is a value of the second timestamp minus a value of the first timestamp.

4. The method of claim 1, further comprising, when the number of incoming event messages over a period of time is less than the threshold amount:
verifying that the number of incoming event messages is less than the threshold amount for a number of intervals.

5. The method of claim 4, wherein the step of verifying that the number of incoming event messages is less than the threshold amount comprises:
setting a counter equal to a number of verification samples;
determining the number of incoming event messages over a verification period of time the length of the interval;
determining the number of incoming event messages is less than the threshold amount;
decrementing the counter; and
repeating the steps of determining the number of incoming event messages, determining the number of incoming event messages is less than the threshold, and decrementing the counter until the counter is equal to zero.

6. The method of claim 5, further comprising, when the counter is equal to zero:
storing a first resynchronization timestamp;
starting a resynchronization process;
storing a first resynchronization message ID, wherein the first resynchronization message ID comprises a first message ID of a received message;
completing the resynchronization process;
storing a second resynchronization timestamp;
storing a second resynchronization message ID, wherein the second resynchronization message ID comprises a second message ID of a received message; and
calculating the number of event messages received during resynchronization divided by a resynchronization interval, wherein the number of event messages received during resynchronization is a value of the second resynchronization message ID minus a value of the first resynchronization message ID and the resynchronization interval is a value of the second resynchronization timestamp minus a value of the first resynchronization timestamp.

7. The method of claim 6, further comprising determining the resynchronization process was not optimal.

8. The method of claim 7, wherein determining the resynchronization process was not optimal comprises:
determining that messages were dropped due to buffer overflow.

9. The method of claim 7, wherein determining the resynchronization process was not optimal comprises:
determining that a resynchronization is required.

10. The method of claim 7, further comprising determining that the number of event messages received during resynchronization divided by a resynchronization interval is less than the threshold.

11. The method of claim 10, further comprising setting the threshold to the greater of a predefined minimum threshold and a large percentage of the number of event messages received during resynchronization divided by a resynchronization interval.

12. The method of claim 11, wherein the percentage is ninety-five percent (95%).

13. The method of claim 7, further comprising determining that the number of event messages received during resynchronization divided by a resynchronization interval is greater than or equal to the threshold.

14. The method of claim 13, further comprising:
determining the number of verification samples is less than a maximum number of verification samples; and
increasing the number of verification samples by one (1).

15. The method of claim 6, further comprising determining the resynchronization process was possibly optimal.

16. The method of claim 15, further comprising calculating an average verification rate as the number of event messages received during the verification periods divided by the length of the interval times the number of verification samples.

17. The method of claim 16, further comprising:
determining the average verification rate is greater than or equal to the number of event messages received during resynchronization divided by a resynchronization interval;
generating a random number;
calculating a percentage difference between the average verification rate and the number of event messages received during resynchronization divided by a resynchronization interval;
determining that the percentage difference is greater than the random number; and
decrementing the number of verification samples by one (1).

18. A non-transitory machine-readable storage medium encoded with instructions for execution by a network management device for timing the delay of a resynchronization at the network management device, the non-transitory machine-readable storage medium comprising:
instructions for defining an interval length;
instructions for determining that a resynchronization is required;
instructions for starting a first timer;
instructions for determining the number of incoming event messages over a period of time the length of the interval;
instructions for determining the number of incoming event messages exceeds a threshold amount;
instructions for starting a second timer; and
instructions for repeating the step of determining the number of incoming event messages over a period of time until the number of incoming event messages is less than the threshold amount.

19. The non-transitory machine-readable storage medium of claim 18, the non-transitory machine-readable storage medium further comprising, instructions for, when the second timer exceeds a predefined maximum, triggering a resynchronization process.

20. The non-transitory machine-readable storage medium of claim 18, wherein the instructions for determining the number of incoming event messages over a period of time further comprises:
instructions for storing a first timestamp at a beginning of a first interval;
instructions for storing a first message ID;
instructions for storing a second timestamp at a beginning of a second interval;
instructions for storing a second message ID; and
instructions for calculating the number of event messages divided by the length of the interval, wherein the number of event messages is a value of the second message ID minus a value of the first message ID and the interval is a value of the second timestamp minus a value of the first timestamp.
